(19) United States
(12) Patent Application Publication
(10) Pub. No.: US 2011/0310753 A1
(43) Pub. Date: Dec. 22, 2011

(54) Measurement configuration in multi-carrier OFDMA wireless communication systems

(75) Inventors: Chao-Chin Chou, Taipei City (TW); Yih-Shen Chen, Hsinchu (TW)

(73) Assignee: MEDIATEK Inc.

(21) Appl. No.: 13/134,810

(22) Filed: Jun. 17, 2011

Related U.S. Application Data
(60) Provisional application No. 61/355,657, filed on Jun. 17, 2010.

(51) Int. Cl. H04W 24/00

(52) U.S. Cl. 370/252

(57) ABSTRACT

Various measurement configurations and s-Measure mechanism in multi-carrier OFDMA systems are provided. In one embodiment, a user equipment (UE) measures a first reference signal received power (RSRP) level in a primary serving cell (Pcell) over a primary component carrier (PCC). The UE also measures a second RSRP level in a secondary serving cell (Scell) over a secondary component carrier (SCC). The UE compares the first RSRP level with a first s-Measure value and compares the second RSRP level with a second s-Measure value. The UE then enables s-Measure mechanism and stops measuring neighbor cells over the PCC if the first RSRP level is higher than the first s-Measure value. The UE also enables s-Measure mechanism and stops measuring neighbor cells over the SCC if the second RSRP level is higher than the second s-Measure value. By having independent s-Measure mechanism and independent s-Measure value, maximum flexibility is achieved.

### CROSS REFERENCE TO RELATED APPLICATION

This application claims priority under 35 U.S.C. §119 from U.S. Provisional Application No. 61/355,657, entitled “Measurement Configuration in the Multi-Carrier OFDMA Wireless Communication Systems,” filed on Jun. 17, 2010, the subject matter of which is incorporated herein by reference.

### TECHNICAL FIELD

The disclosed embodiments relate generally to multi-carrier wireless communication systems, and, more particularly, to measurement configuration in multi-carrier OFDMA systems.

### BACKGROUND

Orthogonal Frequency Division Multiplexing (OFDM) is an efficient multiplexing scheme to perform high transmission rate over frequency selective channel without the disturbance from inter-carrier interference. There are two typical architectures to utilize much wider radio bandwidth for OFDM system. In a traditional OFDM system, a single radio frequency (RF) carrier is used to carry one wideband radio signal, and in a multi-carrier OFDM system, multiple RF carriers are used to carry multiple radio signals with narrower bandwidth. A multi-carrier OFDM system has various advantages as compared to a traditional OFDM system such as better spectrum scalability, better reuse on legacy single-carrier hardware design, more mobile station hardware flexibility, and lower Peak to Average Power Ratio (PAPR) for uplink transmission. Thus, multi-carrier OFDM systems have become the baseline system architecture in IEEE 802.16m™-2011 and 3GPP Release 10 (i.e. for LTE-Advanced system) draft standards to fulfill International Mobile Telecommunications Advanced (IMT-Advanced) system requirements.

Long-Term Evolution (LTE) systems offer high peak data rates, low latency, improved system capacity, and low operating cost resulting from simple network architecture. An LTE system also provides seamless integration to older wireless network, such as GSM, CDMA and Universal Mobile Telecommunication System (UMTS). Enhancements to LTE systems are considered so that they can meet or exceed IMA-Advanced fourth generation (4G) standard. One of the key enhancements is to support bandwidth up to 100 MHz and be backwards compatible with the existing wireless network system. Carrier aggregation (CA) is introduced to improve the system throughput. With carrier aggregation, the LTE-Advanced (LTE-A) system can support peak target data rates in excess of 1 Gbps in the downlink (DL) and 500 Mbps in the uplink (UL). Such technology is attractive because it allows operators to aggregate several smaller contiguous or non-continuous component carriers (CC) to provide a larger system bandwidth, and provides backward compatibility by allowing legacy users to access the system by using one of the component carriers.

In LTE/LTE-A systems, an evolved universal terrestrial radio access network (E-UTRAN) includes a plurality of evolved Node-Bs (eNBs) communicating with a plurality of mobile stations, referred as user equipments (UEs). Typically, each UE needs to periodically measure the received signal quality of the serving cell and neighbor cells and reports the measurement result to its serving eNB for potential handover or cell reselection. The measurement may drain UE battery power. For power saving, a parameter to stop UE's measurement activity (e.g., s-Measure) is sometimes used to reduce the frequency of UE's measurements.

FIG. 1 (Prior Art) illustrates an s-Measure mechanism in a single-carrier LTE system 10. LTE system 10 comprises a UE11, a serving eNB12, and two neighbor eNB13 and eNB14. UE11 is connected to its serving eNB12 over carrier 1 (e.g., serving cell). Reference signal received power (RSRP) measurement of the signal strength of an LTE cell helps to rank between the different cells as input for mobility managements. For example, UE11 measures the RSRP level of its serving cell and the two neighbor cells to determine the signal quality of each cell. Because measuring consumes power on the UEs, it is not efficient for each UE to measure signal qualities of neighbor cells all the time. Typically, when the RSRP level of the serving cell is above a threshold value specified by s-Measure, the UE stops measuring the signal qualities of neighbor cells, as measurements of neighbor cells are no longer necessary.

FIG. 2 (Prior Art) illustrates an s-Measure mechanism in a multi-carrier LTE system 20. LTE system 20 comprises a UE21, a serving eNB22, and two neighbor eNB23 and eNB24. When carrier aggregation is supported, a UE may be served by multiple cells over different component carriers (CCs) of a serving eNB. For example, UE21 is connected to its serving eNB22 over carrier 1 (e.g., primary serving cell (Pcell) on primary component carrier (PCC)) and carriers 2 and 3 (e.g., secondary serving cells (Scells) on secondary component carriers (SCCs)). Similar to the s-Measure mechanism illustrated in FIG. 1, the s-Measure criterion can be tied to the RSRP level of the primary serving cell (Pcell), i.e., the serving cell on PCC. According to the LTE Release-8/9 principle, UE21 stops all measurements of neighbor cells on all CCs when the signal quality of Pcell is above the s-Measure threshold. For example, UE21 stops measuring neighbor cells when the RSRP level of Pcell is above s-Measure, regardless of the RSRP level of Scells over SCCs. Various problems arise when such s-Measure mechanism is used under carrier aggregation.

### SUMMARY

Various measurement configuration and s-Measure mechanism in multi-carrier OFDMA systems are provided.

In a first embodiment, a user equipment (UE) measures a reference signal received power (RSRP) level in a primary serving cell (Pcell) over a primary component carrier (PCC). The UE compares the RSRP level with a threshold value (e.g., s-Measure). The UE then enables s-Measure mechanism and stops measuring neighbor cells over all CCs if the RSRP level is higher than the s-Measure value. The UE also monitors an RSRQ/RSRP level of a configured secondary cell (Scell) over a secondary component carrier (SCC) and obtains Scell signal quality. The UE disables s-Measure mechanism when the Scell signal quality is below the threshold value or when interference of the Scell is detected. The UE starts to measure neighbor cells over all CCs.

In another embodiment, the UE disables s-Measure mechanism when the Scell signal quality is below the threshold value or when interference of the Scell is detected. The UE starts to measure neighbor cells over the SCC. UE may also disable s-Measure mechanism over a carrier frequency deployed by a femtocell and starts to measure neighbor cells over the carrier frequency. When there is a need to detect un-configured CC for SCC addition, the'UE disables s-Measure mechanism over an un-configured CC and starts to measure neighbor cells over the un-configured CC.

In a third embodiment, the UE measures a second RSRP level in the Scell over the SCC. The UE compares the second RSRP level with the same s-Measure value. The UE enables s-Measure mechanism and stops measuring neighbor cells over all CCs if the RSRP level and the second RSRP level are both higher than the s-Measure value. On the other hand, the UE disables s-Measure mechanism when either the RSRP level or the second RSRP level is below the s-Measure value. The UE then starts to measure neighbor cells over all CCs.

In a fourth embodiment, a user equipment (UE) measures a first reference signal received power (RSRP) level in a primary serving cell (Pcell) over a primary component carrier (PCC). The UE also measures a second RSRP level in a secondary serving cell (Scell) over a secondary component carrier (SCC). The UE compares the first RSRP level with a first s-Measure value and compares the second RSRP level with a second s-Measure value. The UE then enables s-Measure mechanism and stops measuring neighbor cells over the PCC if the first RSRP level is higher than the first s-Measure value. The UE also enables s-Measure mechanism and stops measuring neighbor cells over the SCC if the second RSRP level is higher than the second s-Measure value. By having independent s-Measure mechanism and independent s-Measure value, maximum flexibility is achieved.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 (Prior Art) illustrates an s-Measure mechanism in a single carrier LTE system.

FIG. 2 (Prior Art) illustrates an s-Measure mechanism in a multi-carrier LTE system.

FIG. 3 illustrates an s-Measure mechanism in a multi-carrier LTE/LTE-A system in accordance with one novel aspect.

FIG. 4 is a simplified block diagram of a UE and an eNB for measurement configuration in accordance with one novel aspect.

FIGS. 5A and 5B illustrate a problem and solution of configured Scell monitoring with s-Measure mechanism.

FIGS. 6A and 6B illustrate a problem and solution of femtocell detection with s-Measure mechanism.

FIGS. 7A and 7B illustrate a problem and solution of femtocell detection in un-configured CC with s-Measure mechanism.

FIGS. 8A, 8B, and 8C illustrate a problem and solution of SCC management (e.g., SCC addition) with s-Measure mechanism.

FIGS. 9A and 9B illustrate a problem and solution of SCC management (e.g., SCC addition) in a heterogeneous network with s-Measure mechanism.

FIG. 10 is a flow chart of a first solution for measurement configuration of a UE with s-Measure mechanism.

FIG. 11 is a flow chart of a second solution for measurement configuration of a UE with s-Measure mechanism.

FIG. 12 is a flow chart of a third solution for measurement configuration of a UE with s-Measure mechanism.

FIG. 13 is a flow chart of a fourth solution for measurement configuration of a UE with s-Measure mechanism.

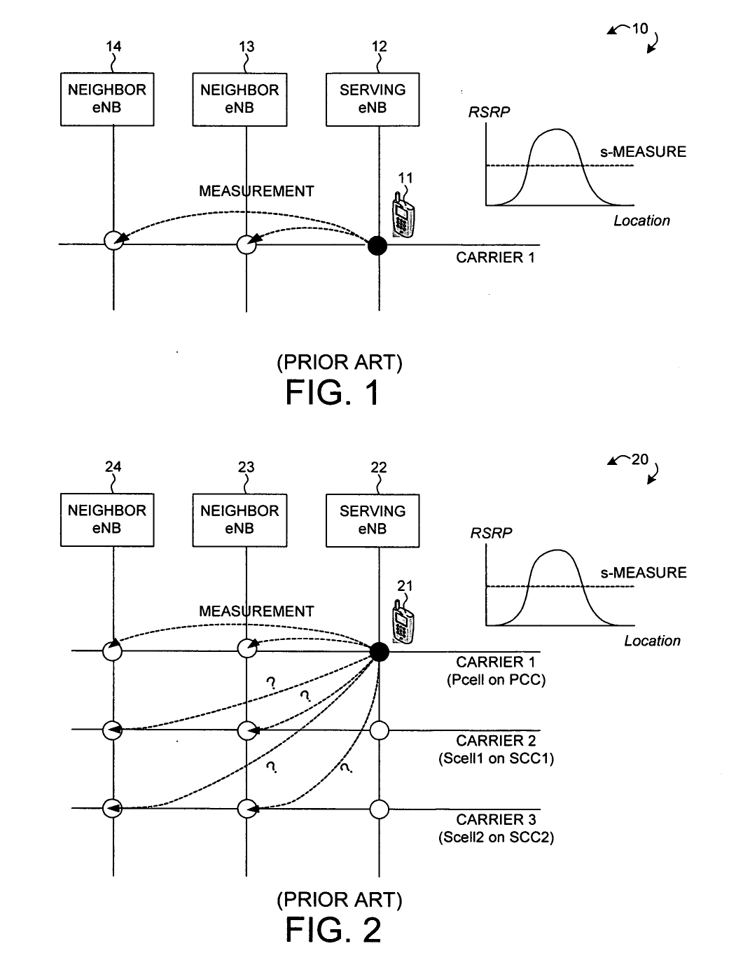

### DETAILED DESCRIPTION

Reference will now be made in detail to some embodiments of the invention, examples of which are illustrated in the accompanying drawings.

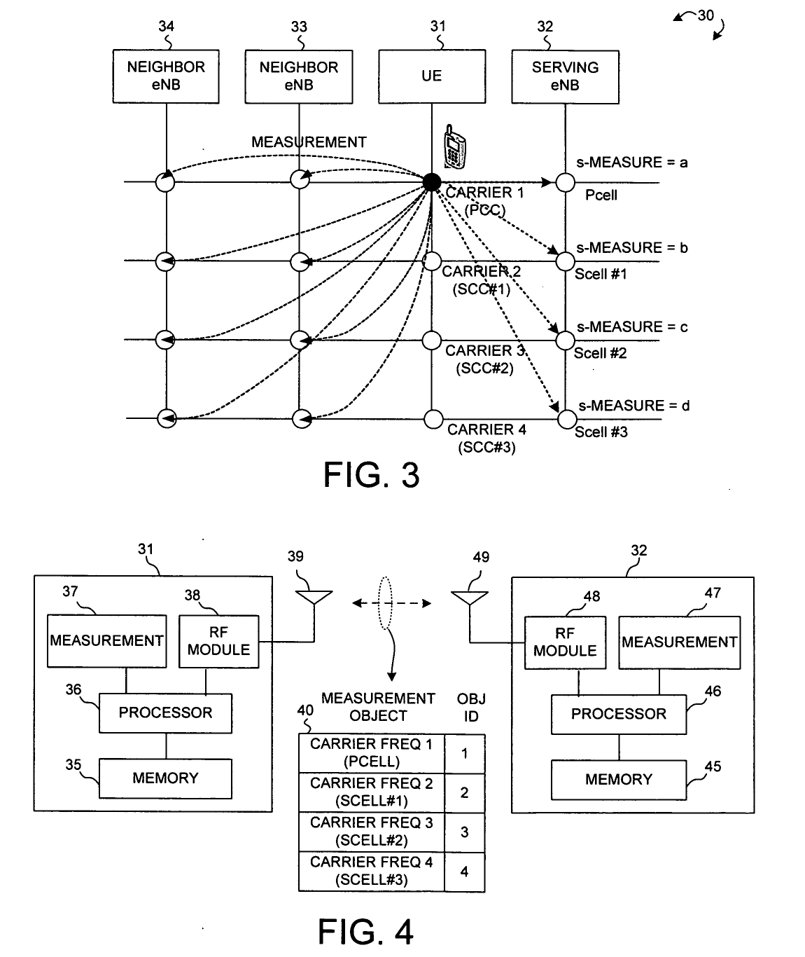

FIG. 3 illustrates an s-Measure mechanism in a multi-carrier LTE/LTE-A system 30 in accordance with one novel aspect. In LTE/LTE-A systems, an evolved universal terrestrial radio access network (E-UTRAN) includes a plurality of evolved Node-Bs (eNBs) communicating with a plurality of mobile stations, referred as user equipments (UEs). Muiti-carrier LTE/LTE-A system 30 comprises a UE31, a serving eNB32, and two neighbor eNB33 and eNB34. When carrier aggregation is supported, a UE may be served by multiple cells over different component carriers (CCs) of a serving eNB. For example, UE31 is served by eNB32 over primary component carrier 1 (e.g., primary serving cell (Pcell) on PCC). UE31 is also served by eNB32 over secondary component carriers 2, 3, and 4 (e.g., secondary serving cells (Scells) on SCCs).

Reference signal received power (RSRP) measurement of the signal strength of an LTE cell helps to rank between the different cells as input for mobility management. RSRP is the average of the power of all resource elements that carry cell-specific reference signals over the entire bandwidth. It can be measured in the OFDM symbols carrying the cell-specific reference signals. For example, UE31 measures the RSRP level of the Pcell to determine the signal quality of the Pcell. In addition, UE31 also needs to measure the RSRP levels of the neighbor cells to determine signal qualities of the neighbor cells. E-UTRNAN measurement events (e.g., A1-A6) may be reported to eNB32 based on the measurement results. Accordingly, eNB32 can make component carrier (CC) management and handover decisions appropriately.

Because measurement activities consume power on the UEs, it is not efficient for each UE to measure signal qualities of neighbor cells over all CCs all the time. For example, under a typical s-Measure mechanism, when the RSRP level of the Pcell is above a threshold value specified by a pre-defined value (e.g., s-Measure), a UE may stop measuring signal qualities of neighbor cells because measurements of neighbor cells may no longer be necessary. With carrier aggregation, however, the signal quality of Pcell over PCC is not determinative as to the signal qualities of Scells over SCCs. For SCC management (e.g., Scell addition), the signal quality of un-configured CCs also needs to be considered.

In accordance with one novel aspect, each component Carrier (CC) may have its own s-Measurement criteria. As illustrated in FIG. 3, the s-Measure threshold values are set to be a, b, c and d for PCC (Pcell), SCC#1 (Scell #1), SCC#2 (Scell #2), and SCC#3 (Scell #3), respectively. As a general concept, UE31 measures the received signal quality of each serving cell over its corresponding CC. UE31 then compares the received signal quality of each serving cell with a corresponding s-Measure threshold value to determine whether to stop measurement activities for neighbor cells over the corresponding CC. For example, UE31 compares the RSRP level of Pcell against its s-measure threshold a. If the RSRP level is above the threshold, then UE31 stops measurement activity of neighbor cells over PCC. Similarly, UE31 compares the RSRP level of Scell #1 against its s-measure threshold b. If the RSRP level is above the threshold, then UE31 stops measurement activity of neighbor cells over SCC#1, and so on so forth. The s-Measure values can be different among the CCs, or can be identical to the s-Measure value on PCC. In addition, the s-Measure mechanism on each CC can be individually enabled or disabled. By having independent s-Measure mechanism and independent s-Measure threshold value, maximum flexibility can be achieved.

FIG. 4 is a simplified block diagram of UE31 and eNB32 for measurement configuration in accordance with one novel aspect. UE31 comprises memory 35, a processor 36, a measurement module 37, and an RF module 38 coupled to an antenna 39. Similarly, eNB32 comprises memory 45, a processor 46, a measurement module 47, and an RF module 48 coupled to an antenna 49. Alternatively, multiple RF modules and multiple antennas may be used for multi-carrier transmission. In carrier aggregation scenario, different carrier frequencies to be measured are specified by measurement objects. A measurement object may be set for each configured CC to measure neighbor cells on that CC. A measurement object may also be set for un-configured CCs to measure neighbor CCs on that CC. In the example of FIG. 4, table 40 lists four object IDs specified for four measurement objects over the four CCs. To save power consumption and to achieve flexibility, the s-Measure mechanism and the s-Measure threshold value for each measurement object of UE31 can be individually disabled/enabled and configured.

How to apply the novel s-Measure mechanism and configuration under carrier aggregation in LTE systems is now described below with respect to various scenarios, problems, and potential solutions.

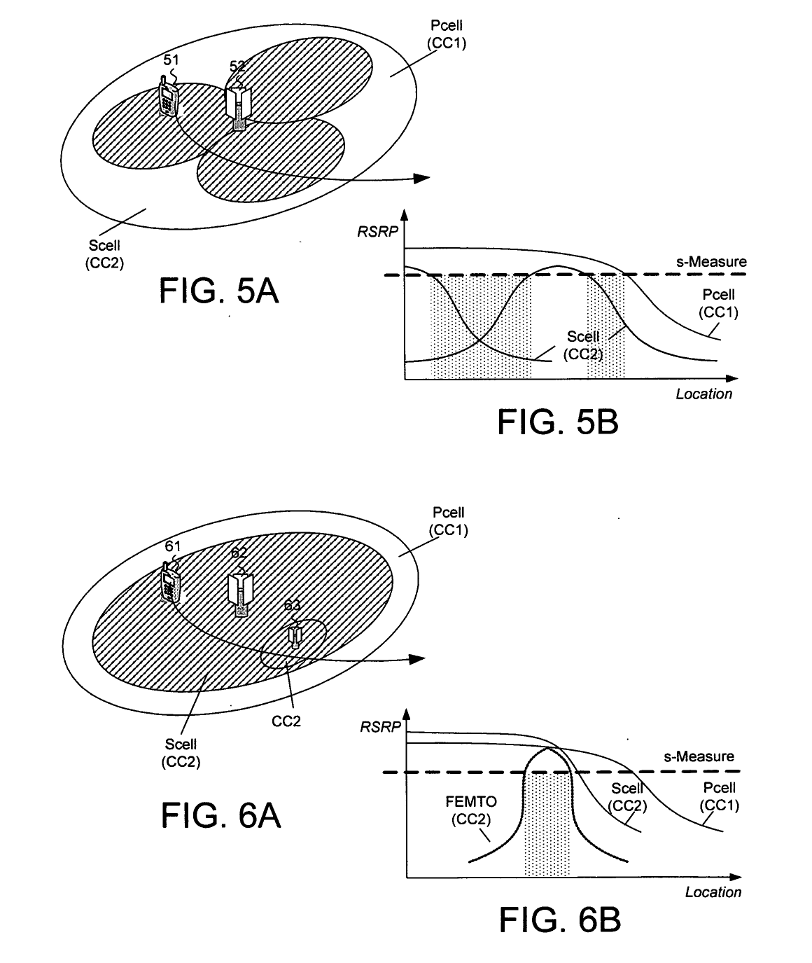

FIGS. 5A and 5B illustrate a problem and solution of configured Scell monitoring with s-Measure mechanism. In FIG. 5A, UE51 is located in the cell coverage area of a primary serving cell (Pcell over CC1) and a secondary serving cell (Scell over CC2) of its serving eNB52. When UE51 travels to the Scell boundary, the Scell signal quality starts to degrade, while the Pcell signal quality remains high. FIG. 5B illustrates the RSRP levels of Pcell and Scell with respect to the UE location. In the example of FIG. 5B, when UE51 travels in the location depicted by the dotted-shade area, the RSRP level of the Pcell is still above the s-Measure threshold. However, the RSRP level of the Scell is below the s-Measure threshold. The Scell signal quality degradation may affect communication quality or result in reduced throughput. In addition, if the signal quality degradation of the Scell cannot be detected, then Scell handover cannot be triggered in time. Therefore, it is desirable that UE51 is aware of the Scell quality even when the Pcell quality is above the s-Measure threshold value.

In accordance with one novel aspect, UE51 obtains the Scell quality and configures its s-Measure mechanism accordingly. For example, UE51 monitors the RSRQ/RSRP level of the configured Scell to obtain the Scell quality. In a first solution, when the Scell quality is below a threshold, UE51 simply disables the s-Measure mechanism and starts all measurements of neighbor cells over all CCs. In a second solution, when the Scell quality is below a threshold, UE51 excludes the s-Measure mechanism on the measurement objects corresponding to the Scell and starts measurements of neighbor cells over the excluded measurement objects. In a third solution, UE51 measures Scell quality as well as Pcell quality, and starts all measurements on neighbor cells over all CCs when one of the cells goes below the same s-Measure threshold. In a fourth solution, UE51 measures Scell quality as well as Pcell quality, but uses independent s-Measure threshold values for Pcell and Scell to independently enable/disable and trigger s-Measure mechanism.

FIGS. 6A and 6B illustrate a problem and solution of femtocell detection with s-Measure mechanism. In FIG. 6A, UE61 is located in the cell coverage area of a primary serving cell (Pcell over CC1) and a secondary serving cell (Scell over CC2) of its serving eNB62. Within the cell coverage of CC1 and CC2, a femtocell is also deployed by a femto eNB63 over the same carrier frequency as CC2. When UE61 travels through the femtocell, the femtocell signal becomes strong, while the Pcell and Scell signal quality remains high. FIG. 6B illustrates the RSRP levels of Pcell, Scell, and femtocell with respect to the UE location. In the example of FIG. 6B, when UE61 travels in the location depicted by the dotted-shade area, the RSRP levels of both Pcell and Scell are above the s-Measure threshold. However, the RSRP level of the femtocell is also very strong, which results in significant interference between the macrocells and the femtocell. Therefore, it is desirable that UE61 detects the femtocell to avoid interference between Scell and femtocell even when the Pcell/Scell quality is above the s-Measure threshold value. It is noted that although a femtocell is used for illustrate, similar problems may apply for a closed-subscriber group cell (CSG cell).

In accordance with one novel aspect, UE61 detects Scell interference and configures its s-Measure mechanism accordingly. For example, UE61 monitors the RSRQ/RSRP level of the configured Scell to detect Scell interference. In a first solution, UE61 monitors the link quality report on the Scell for interference detection. In LTE/LTE-A system, the link quality report could be RSRQ/RSRP or CQI report. When the Scell interference is high, UE61 simply disables the s-Measure mechanism and starts all measurements of neighbor cells over all CCs. In a second solution, UE61 monitors RSRQ/RSRP or CQI reports on the Scell for interference detection. When the Scell interference is high, UE61 excludes the s-Measure mechanism on the measurement objects corresponding to the Scell and starts measurements of neighbor cells over the excluded measurement objects. In a third solution, UE61 monitors CQI reports on the Scell for interference detection, and starts all measurements on neighbor cells over all CCs when interference is detected. In a fourth solution, eNB62 configures UE61 a specific s-Measure value to ease the detection of the femtocell on CC2, or simply disable the s-Measure mechanism on CC2 when interference on Scell is detected.

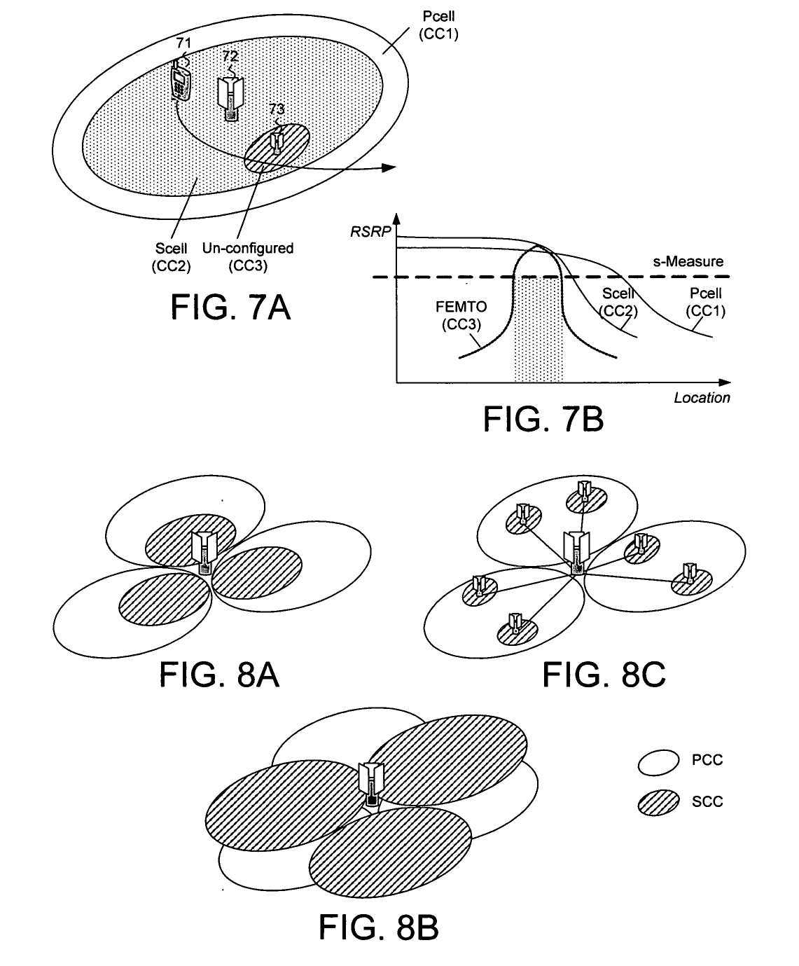

FIGS. 7A and 7B illustrate a problem and solution of femtocell detection in un-configured CC with s-Measure mechanism. In FIG. 7A, UE71 is located in the cell coverage area of a primary serving cell (Pcell over CC1) and a secondary serving cell (Scell over CC2) of its serving eNB72. Within the cell coverage of CC1 and CC2, a femtocell is also deployed by a femto eNB73 over carrier frequency CC3, which is an un-configured CC for UE71. When UE71 travels through the femtocell, the femtocell signal becomes strong, while the Pcell and Scell signal quality remains high. FIG. 7B illustrates the RSRP levels of Pcell, Scell, and femtocell with respect to the UE location. In the example of FIG. 7B, when UE71 travels in the location depicted by the dotted-shade area, the RSRP levels of both Pcell and Scell are above the s-Measure threshold. However, the RSRP level of the femtocell is also very strong. In general, when an open femtocell is deployed in a frequency not used by the overlay macrocell, a UE can detect the femtocell and handover to the femtocell to offload the traffic from the macro eNB and to reduce transmission power for power saving. Therefore, it is desirable that UE71 is able to detect the femtocell even when the Pcell/Scell quality is above the s-Measure threshold value.

In accordance with one novel aspect, UE71 is able to detect the femtocell and configures its s-Measure mechanism accordingly. In a first solution, when UE71 is in the proximity of a femtocell, UE71 simply disables the s-Measure mechanism and starts all measurements of neighbor cells over all CCs. In a second solution, when UE71 is in the proximity of a femtocell, UE71 excludes the s-Measure mechanism on the measurement objects corresponding to the frequency deployed by the femtocell and starts measurements of neighbor cells over the excluded measurement objects. In a third solution, eNB72 explicitly instructs UE71 to disable the s-Measure mechanism, and starts all measurements on neighbor cells over all CCs. Finally, in a fourth solution, the s-Measure mechanism on the frequency deployed by the femtocell is disabled or is configured to have a specific s-Measure value that is easier for femtocell detection.

FIGS. 8A, 8B, and 8C illustrate a problem and solution of SCC management (e.g., SCC addition) with s-Measure mechanism. In FIGS. 8A and 8C, SCC has a smaller coverage than PCC, and the SCC is un-configured. In FIG. 8B, the coverage of SCC is different from the coverage of PCC, and the SCC is un-configured. In general, it is desirable that a UE can detect the potential Scell for new SCC addition even when the Pcell quality is above the s-Measure threshold value.

In accordance with one novel aspect, the UE is able to detect the potential Scell for new SCC addition and configures its s-Measure mechanism accordingly. In a first solution, when there is a need to detect new SCCs, or when instructed by its source eNB, the UE simply disables the s-Measure mechanism and starts all measurements of neighbor cells over all CCs. In a second solution, when there is a need to detect new SCCs, or when instructed by its source eNB, the UE excludes the s-Measure mechanism on the measurement objects corresponding to the un-configured SCC and starts measurements of neighbor cells over the excluded measurement objects. In a third solution, if all serving cells are above the s-Measure value, then the eNB can instruct the UE to perform neighbor cell measurements over all CCs to detect new candidate CCs when needed. In a fourth solution, the eNB can configure different s-Measure value on different CCs to facilitate SCC management on each CC. For example, s-Measure on an un-configured CC can be disabled individually to allow measurements on the new candidate CC. Alternatively, the eNB can explicitly instruct the UE to perform measurements on un-configured CC when there is a need to add new SCC.

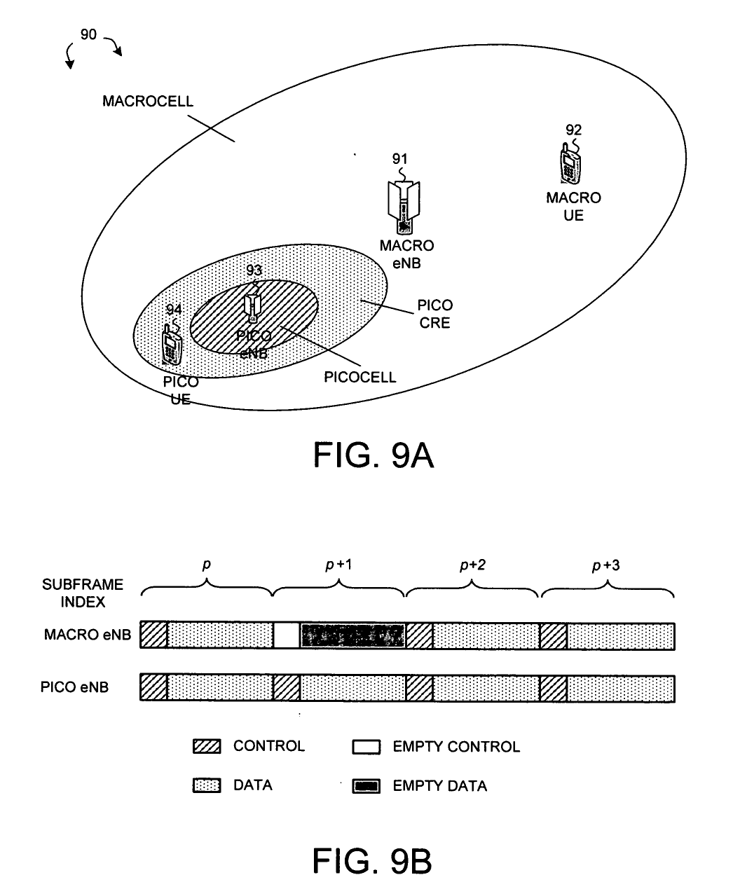

FIGS. 9A and 9B illustrate a problem and solution of SCC management (e.g., SCC addition) in a heterogeneous network 90 with s-Measure mechanism. Network 90 comprises a macro eNB91, a macro UE92, a pico eNB93, and a pico UE94. Macro eNB91 serves UE92 in a macrocell, while pico eNB93 serves UE94 in a picocell inside the coverage of the macrocell. When pico UE94 is located in the cell region extension (CRE) of the picocell, UE94 will be served in the limited transmission opportunities, e.g., almost blank subframes (ABSs). As shown in FIG. 9B, macro eNB91 transmits ABSs (e.g., empty control and data in subframe p+1) in the pico CRE cell. For UE94, when s-Measure mechanism is configured on the pico CRE cell, the measurement result is always higher than the s-Measure value and measurement of neighbor cells is disabled. This prevents further addition of potential Scells. Without the assistance of Scells, the throughput of UE94 can be limited depending on the configuration of ABSs.

In accordance with one novel aspect, UE94 is able to detect the potential Scell for SCC addition and configures its s-Measure mechanism accordingly. In a first solution, when UE94 is served in the CRE, or when instructed by its source eNB, UE94 simply disables the s-Measure mechanism and starts all measurements of neighbor cells over all CCs. In a second solution, when UE94 is served in the CRE, or when instructed by its source eNB, UE94 excludes the s-Measure mechanism on the measurement objects corresponding to the un-configured SCC and starts measurements of neighbor cells over the excluded measurement objects. In a third solution, if all serving cells are above the s-Measure value, then the eNB can instruct the UE to perform neighbor cell measurements over all CCs to detect new candidate CCs when needed. In a fourth solution, the eNB can configure different s-Measure value based on its own configuration of almost blank subframes. For example, s-Measure on an un-configured CC can be disabled individually to allow measurements of neighbor cells on the new candidate CC. Alternatively, the eNB can explicitly instruct the UE to perform measurements on un-configured CC when there is a need to add new SCC.

For the various s-Measure configuration solutions, each solution is now illustrated as a flow chart of a method of measurement configuration to overcome the above-illustrated problems.

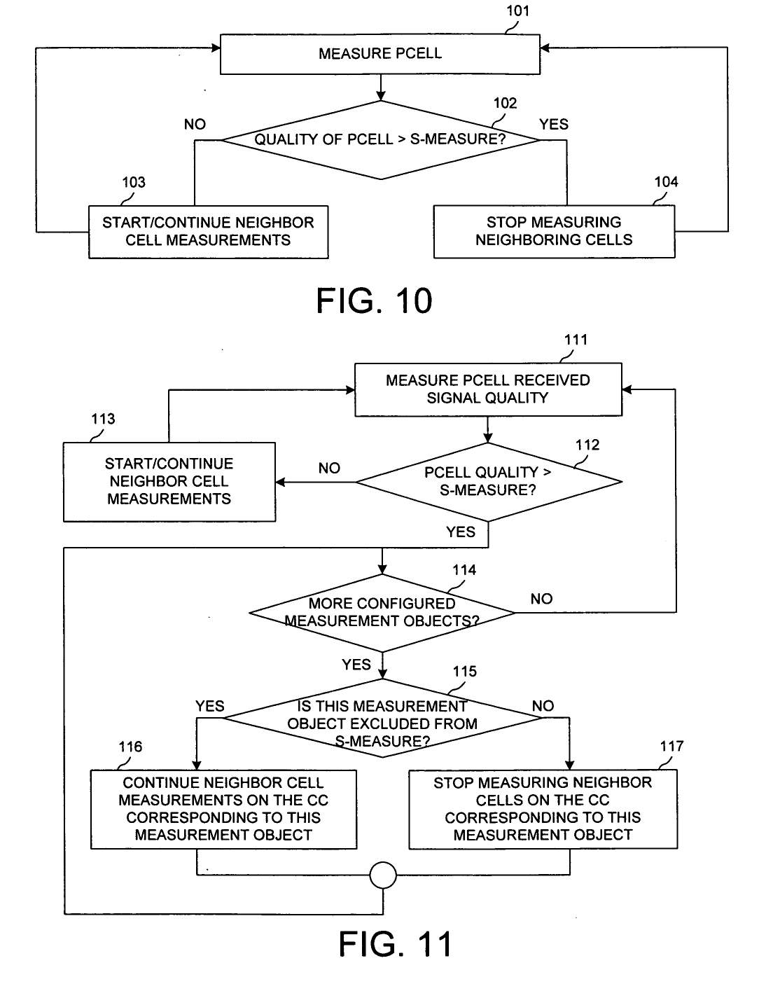

FIG. 10 illustrates the flow chart of a first solution for measurement configuration of a UE with s-Measure mechanism. In step 101, the UE measures received signal quality (e.g., RSRP) over Pcell. The signal quality of Pcell is compared with its s-Measure threshold in step 102. If the Pcell quality is not good (i.e., the RSRP level of the Pcell is below the s-Measure threshold value), then the UE starts to or continues to measure neighbor cells over all CCs in step 103. On the other hand, if the Pcell quality is good (i.e., the RSRP level of the Pcell is above the s-Measure threshold value), then the UE stops measuring neighbor cells over all CCs in step 104.

Although only Pcell quality is used in this s-Measure configuration, the UE continues to monitor RSRQ/RSRP of all configured Scells to obtain Scell quality. Based on the obtained Scell quality, the UE is then able to detect Scell signal degradation issue described in FIGS. 5A and 5B. The UE is also able to detect Scell interference caused by femtocell, as described in FIGS. 6A and 6B. In one embodiment of LTE/LTE-A systems, the UE reports the measurement results of Pcell and Scells by triggering measurement events A1 and A2. With the measurement report, the serving eNB can command the UE to measure neighbor cells. That is, the UE can start neighbor cell measurements over all CCs once Scell signal degradation or Scell interference is detected.

This first solution may eliminate some measurement opportunities of neighboring cells on SCC when the Pcell quality is still above the s-Measure value. One alternative of above-mentioned enhancement is to set relative high s-measure threshold to allow more chance to perform measurements on the Scell frequency. Setting high value of s-Measure, however, would lead to more unnecessary measurements and higher UE power consumption.

FIG. 11 illustrates the flow chart of a second solution for measurement configuration of a UE with s-Measure mechanism. When s-Measure mechanism is enabled, measuring on all frequencies (measurement objects) of neighbor cells is stopped when Pcell signal quality reaches the s-Measure threshold. Additionally, an exclusion mechanism is introduced in the second solution to exclude certain measurement objects, so that measurements of neighbor cells on these frequencies are performed. FIG. 11 illustrates the control flow in which certain carrier frequencies (measurement objects) is excluded from the s-Measure mechanism. In step 111, the UE measures received signal quality (e.g., RSRP) over Pcell. The signal quality of Pcell is compared with its s-Measure threshold in step 112. If the Pcell quality is not good (i.e., the RSRP level of the Pcell is below the s-Measure threshold value), then the UE starts to or continues to measure neighbor cells over all CCs in step 113. Otherwise, if the Pcell quality is good (i.e., the RSRP level of the Pcell is above the s-Measure threshold value), then the UE iterates over all configured measurement objects in step 114. For a measurement object that is excluded from the s-Measure mechanism (step 115), measurement of neighbor cell on this frequency is continued in step 116. For the other measurement objects that are not in the exclusion list, measurements of neighbor cells on this frequency are stopped in step 117.

Compared to solution 1, when Scell signal degradation or Scell interference is detected, the UE does not start measurement of neighbor cells over all CCs in solution 2. Instead, only the measurement objects corresponding to the detected Scell are excluded from the s-Measure mechanism. In other words, when Pcell quality exceeds the s-Measure and when Scell quality is degraded or is interfered, the UE continues to measure neighbor cells over the detected Scell (excluded from s-Measure), but stops measuring neighbor cells over other CCs (not excluded from s-Measure). In addition, under solution 2, the s-Measure mechanism can be excluded (disabled) on the frequency deployed with femtocell or on an un-configured CC when there is a need to add new CC. The s-Measure mechanism can also be excluded (disabled) when UE is served in CRE. Therefore, the problems illustrated in FIGS. 7, 8, and 9 can be more efficiently resolved.

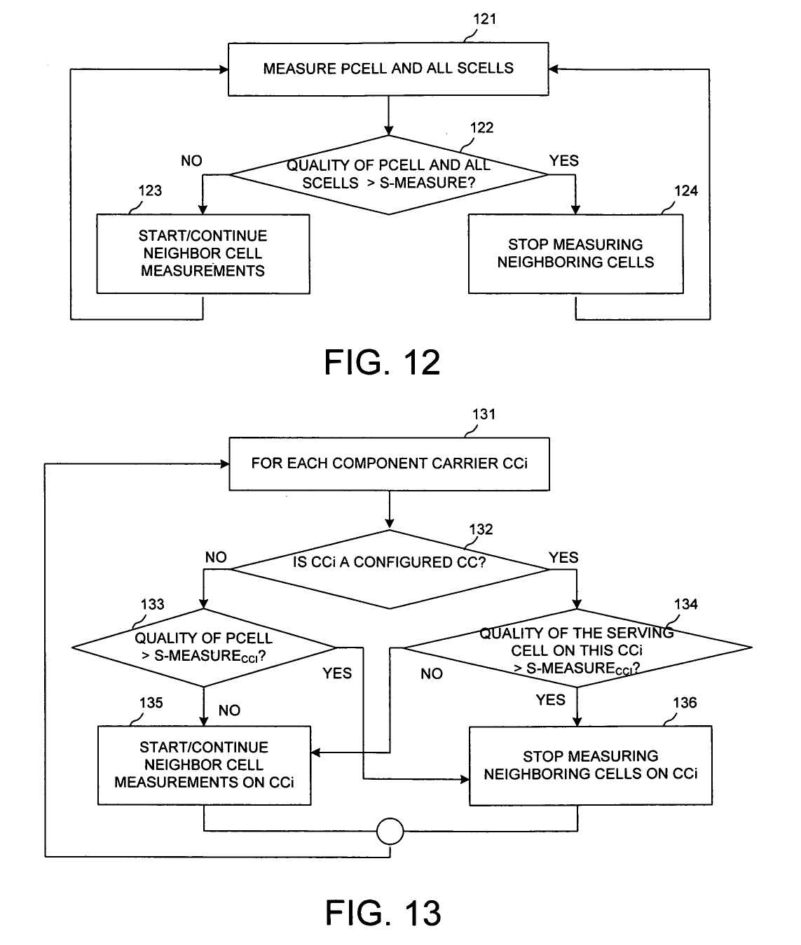

FIG. 12 illustrates the flow chart of a third solution for measurement configuration of a UE with s-Measure mechanism. FIG. 12 illustrates an enhanced s-Measure mechanism, in which s-Measure criteria is applied to both serving Pcell and Scells. In step 121, the UE measures signal qualities for all cells including Pcell and Scells. The signal quality of a cell (Pcell or Scell) is compared with the same s-Measure threshold value in step 122. If the cell qualities are above the threshold, the UE stops measuring neighbor cells over all CCs in step 124. Otherwise, if at least one of the cell qualities is below the threshold, neighbor cell measurements will be started or be continued over all CCs in step 123.

Under the third solution, because the Scell quality is measured and compared continuously, the UE is then able to detect Scell signal degradation issue described in FIGS. 5A and 5B. The UE is also able to detect Scell interference caused by femtocell, as described in FIGS. 6A and 6B. The UE simply starts neighbor cell measurements over all CCs once Scell signal degradation or Scell interference is detected. It is noted that eNB involvement could be minimized. That is, when Scell quality degrades, the UE can invoke neighbor cell measurements without changing the value of s-Measurement by eNB configuration. Similar to solution 2, a slight improvement for this third solution is to exclude only the measurement objects that correspond to the detected Scell, but continue to apply s-Measure over other CCs.

To achieve more flexibility, a fourth solution of measurement configuration is to allow each carrier frequency (measurement object) to have its own s-Measure threshold and the measurements of neighbor cells are controlled independently for each carrier frequency. In this method, s-Measure mechanism works independently on each CC. When the serving cell quality on a CC goes below its s-Measure threshold, the neighbor cell measurements corresponding to that CC are started. On the other hand, when the serving cell quality on a CC is above its s-Measure threshold, the neighbor cell measurements corresponding to the specific CC are stopped. Referring back to FIG. 3, the s-Measure values can be different among the CCs, or can be identical to all the CCs. Furthermore, the s-Measure mechanism on each CC can be enabled or disabled individually.

In one embodiment of the proposed methods, a UE monitors its configured cells of the serving eNB (i.e., Pcell and Scell). The UE derives measurements by the monitoring and reports the measurement results to serving eNB. The measurement report can be triggered by measurement event A1 or measurement event A2. The measurement event A1 indicates that the serving cell quality is better than a pre-defined threshold and the measurement event A2 indicates that the serving cell quality is below than a pre-defined threshold. The UE also compares the measurement data with S-measurement, where the comparison criterion is based on one of the four proposed methods. If the criterion is met, the UE measures the neighboring cells.

FIG. 13 illustrates the flow chart of a fourth solution for measurement configuration of a UE with s-Measure mechanism. The UE iterates over all component carriers CCᵢ one by one in step 132. For each configured CCᵢ (e.g., there is a serving cell), the serving cell signal quality is compared against this CCᵢ's threshold (e.g., s-Measure_{CCi}) in step 134. Otherwise, for each un-configured CCᵢ (e.g., there is no serving cell), the Pcell signal quality is compared against this CCᵢ's threshold (e.g., s-Measure_{CCi}) in step 133. When the signal quality is above the threshold, measurements of neighbor cell on that CCᵢ will be stopped (step 136). Otherwise, measurements of neighbor cells on that CCᵢ are continued or started (step 135). Because the s-Measure mechanism for each CCᵢ can be individually disabled/enabled and the s-Measure threshold for each CCᵢ can be individually configured, maximum flexibility is achieved under solution four with more signaling overhead.

Although the present invention is described above in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
measuring a received signal power in a primary serving cell (Pcell) over a primary component carrier (PCC) by a user equipment (UE) in a multi-carrier wireless communication system;
monitoring an RSRQ/RSRP level of a configured secondary cell (Scell) and thereby obtaining Scell signal quality;
comparing the received signal power with a threshold value (s-Measure); and
enabling s-Measure mechanism and stop measuring neighbor cells over all CCs if the received signal power is higher than the s-Measure value.

2. The method of claim 1, further comprising:
disabling s-Measure mechanism when the Scell signal quality is below the threshold value or when interference of the Scell is detected, wherein the UE starts to measure neighbor cells over all CCs.

3. The method of claim 1, further comprising:
disabling s-Measure mechanism over the Scell when the Scell signal quality is below the threshold value or when interference of the Scell is detected, wherein the UE starts to measure neighbor cells over the SCC.

4. The method of claim 1, wherein the UE disables s-Measure mechanism over a carrier frequency deployed by a femtocell, wherein the UE starts to measure neighbor cells over the carrier frequency.

5. The method of claim 1, wherein the UE disables s-Measure mechanism over an un-configured CC when there is a need to detect the un-configured CC for SCC addition, wherein the UE starts to measure neighbor cells over the un-configured CC.

6. The method of claim 1, further comprising:
measuring a second received signal power in a secondary serving cell (Scell) over SCC; and
enabling s-Measure mechanism and stop measuring neighbor cells over all CCs if the received signal power and the second received signal power are both higher than the s-Measure value.

7. The method of claim 6, wherein the UE disables s-Measure mechanism when either the received signal power or the second received signal power is below the s-Measure value, and wherein the UE starts to measure neighbor cells over all CCs.

8. The method of claim 6, wherein the UE disables s-Measure mechanism when a channel quality indicator (CQI) indicates interference on the Scell, and wherein the UE starts to measure neighbor cells over all CCs.

9. A user equipment (UE), comprising:
an RF module that receives a first reference signal from a primary serving cell (Pcell) over a primary component carrier (PCC) in a multi-carrier wireless communication system;
an RF module that receives a second reference signal from a secondary serving cell (Scell) over a secondary component carrier (SCC) and derives Scell signal quality; and
a measurement module that compares a first reference signal received power (RSRP) level with a threshold value (s-Measure), wherein the UE enables s-Measure mechanism and stops measuring neighbor cells over all CCs if the first RSRP level is higher than the s-Measure value.

10. The UE of claim 9, wherein the UE disables s-Measure mechanism over the Scell when the Scell signal quality is below the threshold value or when interference of the Scell is detected, and wherein the UE starts to measure neighbor cells over the SCC.

11. The UE of claim 9, wherein the UE disables s-Measure mechanism over a carrier frequency deployed by a femtocell, and wherein the UE starts to measure neighbor cells over the carrier frequency.

12. The UE of claim 9, wherein the UE disables s-Measure mechanism over an un-configured CC when there is a need to detect the un-configured CC for SCC addition, and wherein the UE starts to measure neighbor cells over the un-configured CC.

13. The UE of claim 9, wherein the measurement module also compares a second reference signal received power (RSRP) level with the s-Measure value, and wherein the UE enables s-Measure mechanism and stops measuring neighbor cells over all CCs if the first RSRP and the second RSRP are both higher than the s-Measure value.

14. The UE of claim 13, wherein the UE disables s-Measure mechanism when either the first RSRP or the second RSRP is below the s-Measure value, and wherein the UE starts to measure neighbor cells over all CCs.

15. The UE of claim 13, wherein the UE disables s-Measure mechanism when a channel quality indicator (CQI) indicates interference on the Scell, and wherein the UE starts to measure neighbor cells over all CCs.

16. A method, comprising:
measuring a first received signal power in a primary serving cell (Pcell) over a primary component carrier (PCC) by a user equipment (UE) in a multi-carrier wireless communication system;
enabling s-Measure mechanism and stopping measuring for neighboring cells over PCC if the first received signal power is higher than a first s-Measure value;
measuring a second received signal power in a secondary serving cell (Scell) over a secondary component carrier (SCC) by the UE; and
enabling s-Measure mechanism and stopping measuring for neighboring cells over the SCC if the second received signal power is higher than a second s-Measure value.

17. The method of claim 16, further comprising:
monitoring an CQI on the Scell for interference detection; and
disabling s-Measure mechanism over the Scell when interference of the Scell is detected, wherein the UE starts to measure neighbor cells over the SCC.

18. The method of claim 16, wherein the UE disables s-Measure mechanism over a carrier frequency deployed by a femtocell, and wherein the UE starts to measure neighbor cells over the carrier frequency.

19. The method of claim 16, wherein the UE disables s-Measure mechanism over an un-configured CC when there is a need to detect the un-configured CC for SCC addition, and wherein the UE starts to measure neighbor cells over the un-configured CC.

20. The method of claim 16, wherein measurements of neighbor cells on an un-configured CC are decided by comparing the first received signal power in Pcell against the first s-Measure value.

21. The method of claim 16, wherein measurements of neighbor cells on an un-configured CC are decided by comparing the first received signal power in Pcell against a third s-Measure value of the un-configured CC.

22. A user equipment (UE), comprising:
a first RF module that receives a first reference signal in a primary serving cell (Pcell) over a primary component carrier (PCC) in a multi-carrier wireless communication system;
a second RF module that receives a second reference signal in a secondary serving cell (Scell) over a secondary component carrier (SCC);
a measurement module that compares a first reference signal received power (RSRP) level with a first s-Measure value and compares a second RSRP level with a second s-Measure value, wherein the UE enables s-Measure mechanism and stops measuring neighbor cells over the PCC if the first RSRP level is higher than the first s-Measure value, and wherein the UE enables s-Measure mechanism and stops measuring neighbor cells over the SCC if the second RSRP level is higher than the second s-Measure value.

23. The UE of claim 22, wherein the UE monitors an CQI on the Scell for interference detection, wherein the UE disables s-Measure mechanism over the Scell when interference of the Scell is detected, and wherein the UE starts to measure neighbor cells over the SCC.

24. The UE of claim 22, wherein the UE disables s-Measure mechanism over a carrier frequency deployed by a femtocell, and wherein the UE starts to measure neighbor cells over the carrier frequency.

25. The UE of claim 22, wherein the UE disables s-Measure mechanism over an un-configured CC when there is a need to detect the un-configured CC for SCC addition, and wherein the UE starts to measure neighbor cells over the un-configured CC.

26. The UE of claim 22, wherein measurements of neighbor cells on an un-configured CC are decided by comparing the first received signal power in Pcell against the first s-Measure value.

27. The UE of claim 22, wherein measurements of neighbor cells on an un-configured CC are decided by comparing the first received signal power in Pcell against a third s-Measure value of the un-configured CC.
